(19) United States
(12) Patent Application Publication
(10) Pub. No.: US 2013/0319197 A1
(43) Pub. Date: Dec. 5, 2013

(54) Safety structure for rotary paper trimmer

(71) Applicant: Koc-Sing CO, KOWLOON (HK)

(72) Inventor: Koc-Sing CO, KOWLOON (HK)

(73) Assignee: COSIMEX (H.K.) LIMITED, KOWLOON (HK)

(21) Appl. No.: 13/485,952

(22) Filed: Jun. 1, 2012

(51) Int. Cl. B26D 7/22; B26D 1/18

(52) U.S. Cl. 83/478

(57) ABSTRACT

A safety structure for rotary paper trimmer comprises a carriage, a cartridge, a blade holder, a locking means, an unlocking means, a biasing means and an actuating means. The blade holder is received inside the cartridge for holding a cutting blade and slides downward to expose a cutting edge of the cutting blade outside the cartridge during cutting operation. By means of the cooperation among the locking means, the unlocking means, the biasing means and the actuating means, the cutting edge is ensured to be concealed completely inside the cartridge when the cartridge is removed from the carriage and when the carriage cover is not pressed by the user, therefore preventing the cutting edge from injuring the user when the rotary paper trimmer is not in use.

### BACKGROUND OF THE INVENTION

The present invention relates to a cutting apparatus and more specifically pertains to a safety structure for a rotary paper trimmer.

Rotary paper trimmers are commonly available in the marketplace. It usually comprises a paper cutting board with a rail disposed thereon, and a carriage sliding along the rail. The carriage encases a blade cartridge which is disposed with a rotary cutting blade therein. The cutting edge of the rotary cutting blade is exposed from the bottom of the cartridge for cutting a paper placed on the paper cutting board as the carriage slides along the rail.

It is necessary for users to replace the rotary cutting blade in the blade cartridge from time to time. However, the exposed cutting edge of the rotary cutting blade on the bottom of the cartridge easily injures the user as the user is not aware of the exposed cutting edge. Some cartridges available in the marketplace are provided with safety means to prevent unintended exposure of the cutting blade from the cartridge, but such safety means are complicated in structure and thus susceptible to a high production costs. Their operation is also complicated due to the highly complicated structure.

### BRIEF SUMMARY OF THE INVENTION

In view of the aforesaid disadvantages, it is an object of the present invention to provide a safety structure for rotary paper trimmer which is simple in structure and easy to use.

To attain this, the present invention comprises
a carriage for sliding along a rail;
a cartridge removably received in the carriage;
a blade holder received inside the cartridge for holding a cutting blade and slides downward to expose a cutting edge of the cutting blade outside the cartridge during cutting operation, and the blade holder has a first side and a second side opposite thereto;
a locking means disposed inside the cartridge and engaged with the first side of the blade holder and is resiliently biased to block against downward movement of the blade holder;
an unlocking means comprising an elongated slot provided at the cartridge and a corresponding elongated protrusion provided inside the carriage; the elongated protrusion is positioned in such a way that as the cartridge is inserted into the carriage and the elongated slot slides downward along the elongated protrusion, the elongated protrusion comes into contact with the locking means and thereafter disengages the locking means from the blade holder when the cartridge is completely received in the carriage, thereby rendering the locking means no longer blocking against downward movement of the blade holder;
a biasing means disposed inside the cartridge and engaged with the second side of the blade holder and is resiliently biased to block against downward movement of the blade holder; and
an actuating means provided at the carriage for exerting downward force to the blade holder to overcome biasing force of the biasing means to move the blade holder downward when the cartridge is completely received in the carriage.

More particularly, the blade holder comprises a first shoulder at the first side, a second shoulder at the second side, and a push button at its top; and the push button is exposed outside the cartridge when the locking means and the biasing means are biased to block against downward movement of the blade holder.

The carriage comprises a carriage body and a carriage cover pivotally connected to the carriage body; the actuating means is in form of a protrusion extending downward from an inner surface of the carriage cover, and the protrusion is positioned to push the push button of the blade holder downward when the carriage cover is pressed downward and closed towards the carriage body.

The locking means comprises a latch member having a first end and a second end, and a compression coil spring; the first end of the latch member is in form of a downward slope surface; one end of the compression spring leans against an inner surface of the cartridge, and an other end of the compression coil spring acts towards the second end of the latch member to bias the latch member towards the first side of the blade holder into engagement with the first shoulder of the blade holder from below.

The elongated protrusion is provided with an upward slope surface at its top; the latch member is positioned in such a way that when it has not come into contact with the elongated protrusion a bottom end of the downward slope surface of the elongated slot corresponds to a top end of the upward slope surface of the elongated protrusion, and as the top end of the upward slope surface comes into contact with the bottom end of the downward slope surface, the downward slope surface continues to move downward along the upward slope surface and is thereby pushed away from the blade holder until the latch member is completely disengaged from the blade holder.

The biasing means is in form of an elbow spring with one end thereof leaning against the inner wall of the cartridge and an other end thereof acting towards the second shoulder of the blade holder from below.

The biasing means is configured in such a way that it is only possible for the actuating means to overcome the biasing force of the biasing means after the locking means is disengaged from the blade holder. More particularly, the first shoulder has a lower end for engaging with the locking means, and the second shoulder has a lower end for engaging with the biasing means, and the lower end of the first shoulder is at a lower horizontal level than the lower end of the second shoulder.

The operation of the present invention is as follows:

When the cartridge is removed from the carriage, the locking means blocks against downward movement of the blade holder, thereby maintaining the cutting blade to be completely concealed inside the cartridge.

When the cartridge is inserted into the carriage body, the elongated slot slides downward along the elongated protrusion until the latch member comes into contact with the elongated protrusion; the downward force exerted by the user to push the cartridge into the carriage causes the downward slope surface of the latch member to continue to move downward along the upward slope surface of the elongated protrusion, and is thereby pushed away from the blade holder; by the time when the cartridge is completely received in the carriage, the latch member is completely disengaged from the blade holder. At this time, the elbow spring of the biasing means still blocks against downward movement of the blade holder relative to the cartridge, and thus maintains the cutting blade completely concealed inside the cartridge.

To use the rotary paper trimmer, the user closes the carriage cover towards the carriage body. The protrusion in the carriage cover pushes the push button of the blade holder downward as the carriage cover is pressed downward and closed towards the carriage body. The downward force exerted by the downward movement of the carriage cover overcomes the biasing force of the elbow spring and so the blade holder moves is pressed downward to expose the cutting edge outside the cartridge. The user then keeps pressing the carriage cover and slides the carriage body along the rail to cut the paper positioned under the rail. Once the cutting operation is completed, the user releases the carriage cover, and thus the elbow spring again biases the blade holder upward to conceal the cutting edge completely inside the cartridge.

By means of the present invention, the cutting edge is ensured to be concealed completely inside the cartridge when the cartridge is removed from the carriage and when the carriage cover is not pressed by the user, therefore preventing the cutting edge from injuring the user when the rotary paper trimmer is not in use. Therefore, when the user needs to replace the cartridge, the user is protected from being injured by the cutting edge of the cartridge.

### BRIEF DESCRIPTION OF THE DRAWINGS

FIG. 1 is an exploded view of the present invention.

FIG. 2 illustrates the structure of the cartridge and the blade holder when the cartridge is removed from the carriage.

FIG. 3 illustrates the structure of the cartridge, the blade holder and the carriage when the cartridge is inserted into the carriage.

FIG. 4 illustrates the structure of the cartridge, the blade holder and the carriage when the cartridge is completely received in the carriage.

FIG. 5 illustrates the present invention assembled to a rotary paper trimmer.

### DETAILED DESCRIPTION OF THE INVENTION

The present invention is further described in detail below with reference to an embodiment and the accompanying drawings, but the present invention is not limited to the description therein.

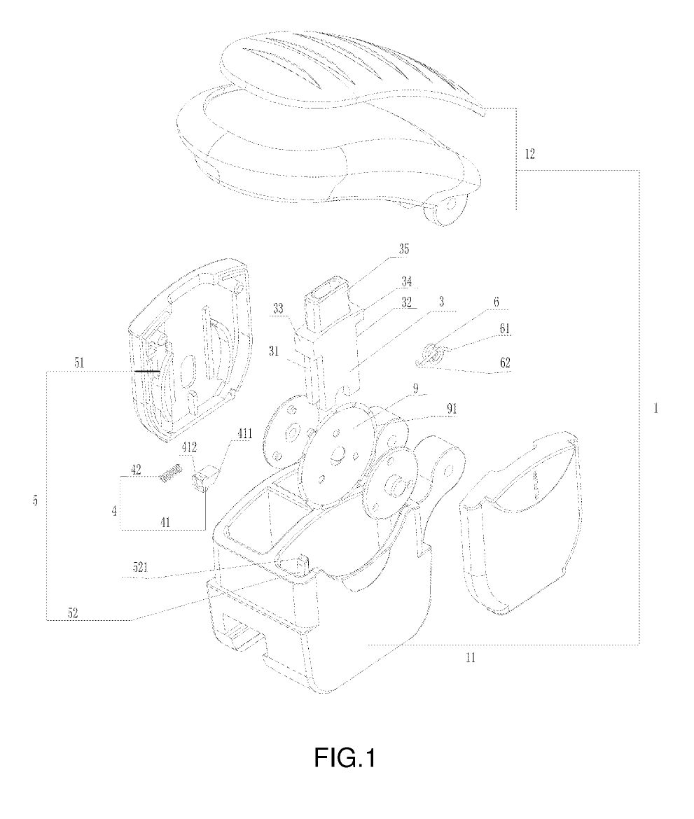

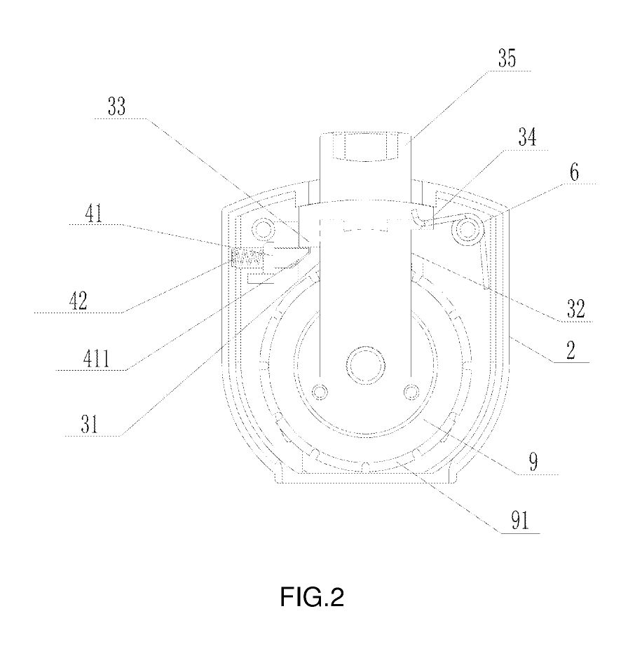

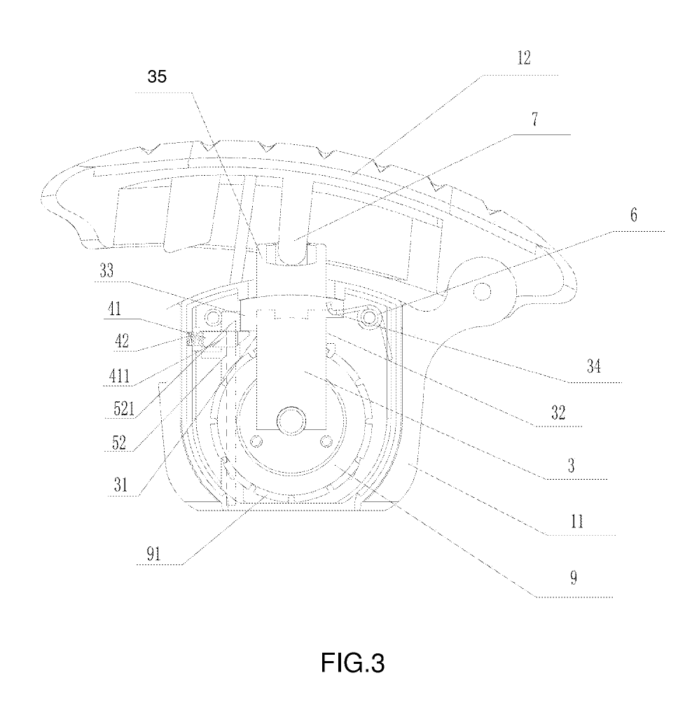

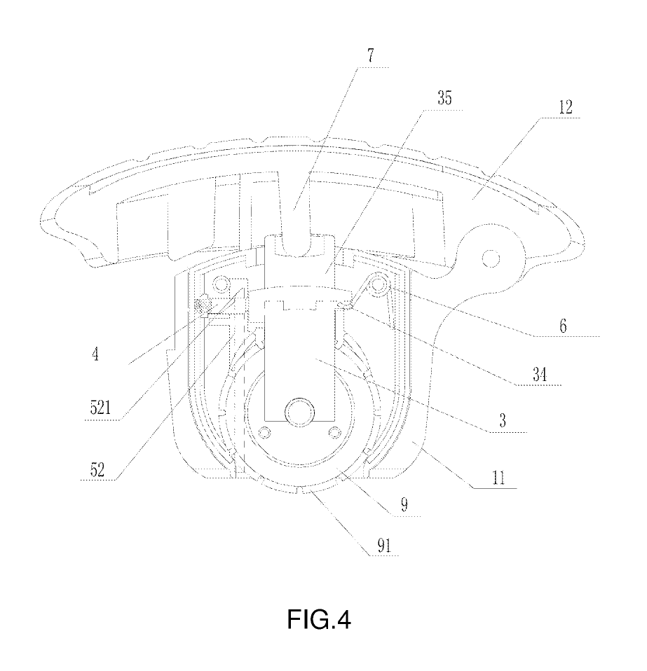

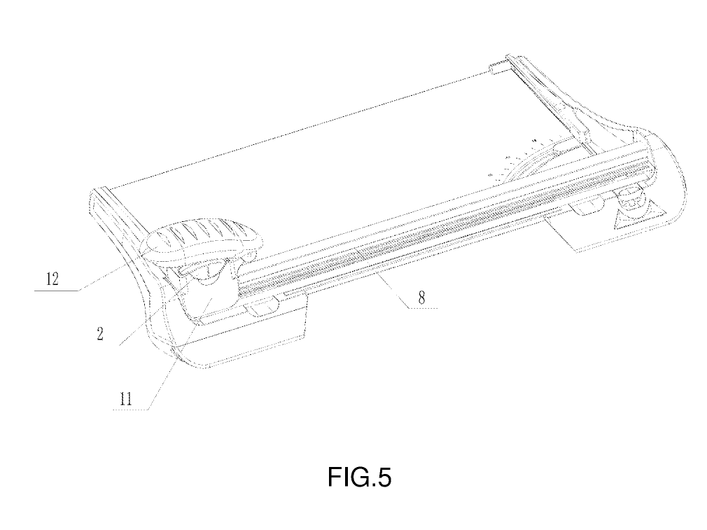

As shown in FIG. 1 to FIG. 5, the safety structure for rotary paper trimmer according to the present invention comprises a carriage 1, a cartridge 2, a blade holder 3, a locking means 4, an unlocking means 5, a biasing means 6 and an actuating means 7.

The carriage 1 slides along a rail 8. The carriage 1 comprises a carriage body 11 and a carriage cover 12 pivotally connected to the carriage body 11. The cartridge 2 is removably received in the carriage 1.

The blade holder 3 is received inside the cartridge 2 for holding a cutting blade 9 and slides downward to expose a cutting edge 91 of the cutting blade 9 outside the cartridge 2 during cutting operation. The blade holder 3 has a first side 31, a second side 32 opposite thereto, a first shoulder 33 at the first side 31, a second shoulder 34 at the second side 32, and a push button 35 at its top. The push button 35 is exposed outside the cartridge 2 when the locking means 4 and the biasing means 5 are biased to block against downward movement of the blade holder 3.

The locking means 4 is disposed inside the cartridge 2 and engaged with the first side 31 of the blade holder 3 and is resiliently biased to block against downward movement of the blade holder 3. In this embodiment, the locking means 4 comprises a latch member 41 having a first end and a second end 412, and a compression coil spring 42; the first end of the latch member 41 is in form of a downward slope surface 411; one end of the compression coil spring 42 leans against an inner surface of the cartridge 2, and an other end of the compression spring 42 acts towards the second end 412 of the latch member 41 to bias the latch member 41 towards the first side 31 of the blade holder 3 into engagement with the first shoulder 33 of the blade holder 3 from below.

The unlocking means 5 comprises an elongated slot 51 provided at the cartridge 2 and a corresponding elongated protrusion 52 provided inside the carriage 1; the elongated protrusion 52 is positioned in such a way that as the cartridge 2 is inserted into the carriage 1 and the elongated slot 51 slides downward along the elongated protrusion 52, the elongated protrusion 52 comes into contact with the locking means 4 and thereafter disengages the locking means 4 from the blade holder 3 when the cartridge 2 is completely received in the carriage 1, thereby rendering the locking means 4 no longer blocking against downward movement of the blade holder 3. The elongated protrusion 52 is provided with an upward slope surface 521 at its top; the latch member 41 is positioned in such a way that when it has not come into contact with the elongated protrusion 52 a bottom end of the downward slope surface 411 corresponds to a top end of the upward slope surface 521 of the elongated protrusion 52, and as the top end of the upward slope surface 521 comes into contact with the bottom end of the downward slope surface 411, the downward slope surface 411 continues to move downward along the upward slope surface 521 and is thereby pushed away from the blade holder 3 until the latch member 41 is completely disengaged from the blade holder 3.

The biasing means 6 is disposed inside the cartridge 2 and engaged with the second side 32 of the blade holder 3 and is resiliently biased to block against downward movement of the blade holder 3. The biasing means 6 is in form of an elbow spring with one end 61 thereof leaning against the inner wall of the cartridge 2 and an other end 62 thereof acting towards the second shoulder 34 of the blade holder 3 from below.

The actuating means 7 is provided at the carriage 1 for exerting downward force to the blade holder 3 to overcome biasing force of the biasing means 6 to move the blade holder 3 downward when the cartridge 2 is completely received in the carriage 1. In this embodiment, the actuating means 7 is in form of a protrusion extending downward from an inner surface of the carriage cover 12, and the protrusion is positioned to push the push button 35 of the blade holder 3 downward when the carriage cover 12 is pressed downward and closed towards the carriage body 11. The biasing means 7 is configured in such a way that it is only possible for the actuating means 7 to overcome the biasing force of the biasing means 6 after the locking means 4 is disengaged from the blade holder 3. More particularly, the first shoulder 33 has a lower end for engaging with the locking means 6, and the second shoulder 34 has a lower end for engaging with the biasing means 6, and the lower end of the first shoulder 33 is at a lower horizontal level than the lower end of the second shoulder 34.

The operation of the present embodiment is as follows:

When the cartridge 2 is removed from the carriage 1, the locking means 4 blocks against downward movement of the blade holder 3, thereby maintaining the cutting blade 9 to be completely concealed inside the cartridge 2.

When the cartridge 2 is inserted into the carriage body 11, the elongated slot 51 slides downward along the elongated protrusion 52 until the latch member 41 comes into contact with the elongated protrusion 52; the downward force exerted by the user to push the cartridge 2 into the carriage 1 causes the downward slope surface 411 of the latch member 4 to continue to move downward along the upward slope surface 521 of the elongated protrusion 52, and is thereby pushed away from the blade holder 3; by the time when the cartridge 2 is completely received in the carriage 1, the latch member 4 is completely disengaged from the blade holder 3. At this time, the biasing means 6 in form of the elbow spring still blocks against downward movement of the blade holder 3 relative to the cartridge 2, and thus maintains the cutting blade 9 completely concealed inside the cartridge 2.

To use the rotary paper trimmer, the user closes the carriage cover 12 towards the carriage body 11. The actuating member 7 in form of the protrusion in the carriage cover 12 pushes the push button 35 of the blade holder 3 downward as the carriage cover 12 is pressed downward and closed towards the carriage body 11. The downward force exerted by the downward movement of the carriage cover 12 overcomes the biasing force of the biasing means 6 in form of the elbow spring and so the blade holder 3 moves is pressed downward to expose the cutting edge 91 outside the cartridge 2. The user then keeps pressing the carriage cover 12 and slides the carriage body 1 along the rail 8 to cut the paper positioned under the rail 8. Once the cutting operation is completed, the user releases the carriage cover 12, and thus the biasing means 6 in form of the elbow spring again biases the blade holder 3 upward to conceal the cutting edge 91 completely inside the cartridge 2.

The above embodiment is a more preferred description of the present invention. However, description of the present invention is not limited by the above embodiment. Any other changes, modification, substitution, combinations and simplification not deviated from the spiritual essence and principle of the present invention are equivalent replacement and they all fall into the scope of protection of the present invention.

What is claimed is:

1. A safety structure for rotary paper trimmer which comprises
a carriage for sliding along a rail;
a cartridge removably received in the carriage;
a blade holder received inside the cartridge for holding a cutting blade and slides downward to expose a cutting edge of the cutting blade outside the cartridge during cutting operation, and the blade holder has a first side and a second side opposite thereto;
a locking means disposed inside the cartridge and engaged with the first side of the blade holder and is resiliently biased to block against downward movement of the blade holder;
an unlocking means comprising an elongated slot provided at the cartridge and a corresponding elongated protrusion provided inside the carriage; the elongated protrusion is positioned in such a way that as the cartridge is inserted into the carriage and the elongated slot slides downward along the elongated protrusion, the elongated protrusion comes into contact with the locking means and thereafter disengages the locking means from the blade holder when the cartridge is completely received in the carriage, thereby rendering the locking means no longer blocking against downward movement of the blade holder;
a biasing means disposed inside the cartridge and engaged with the second side of the blade holder and is resiliently biased to block against downward movement of the blade holder; and
an actuating means provided at the carriage for exerting downward force to the blade holder to overcome biasing force of the biasing means to move the blade holder downward when the cartridge is completely received in the carriage.

2. The safety structure for rotary paper trimmer as in claim 1, wherein the blade holder comprises a first shoulder at the first side, a second shoulder at the second side, and a push button at its top; and the push button is exposed outside the cartridge when the locking means and the biasing means are biased to block against downward movement of the blade holder.

3. The safety structure for rotary paper trimmer as in claim 2, wherein the carriage comprises a carriage body and a carriage cover pivotally connected to the carriage body; the actuating means is in form of a protrusion extending downward from an inner surface of the carriage cover, and the protrusion is positioned to push the push button of the blade holder downward when the carriage cover is pressed downward and closed towards the carriage body.

4. The safety structure for rotary paper trimmer as in claim 3, wherein the locking means comprises a latch member having a first end and a second end, and a compression coil spring; the first end of the latch member is in form of a downward slope surface; one end of the compression spring leans against an inner surface of the cartridge, and an other end of the compression coil spring acts towards the second end of the latch member to bias the latch member towards the first side of the blade holder into engagement with the first shoulder of the blade holder from below.

5. The safety structure for rotary paper trimmer as in claim 4, wherein the elongated protrusion is provided with an upward slope surface at its top; the latch member is positioned in such a way that when it has not come into contact with the elongated protrusion a bottom end of the downward slope surface of the elongated slot corresponds to a top end of the upward slope surface of the elongated protrusion, and as the top end of the upward slope surface comes into contact with the bottom end of the downward slope surface, the downward slope surface continues to move downward along the upward slope surface and is thereby pushed away from the blade holder until the latch member is completely disengaged from the blade holder.

6. The safety structure for rotary paper trimmer as in claim 5, wherein the biasing means is in form of an elbow spring with one end thereof leaning against the inner wall of the cartridge and an other end thereof acting towards the second shoulder of the blade holder from below.

7. The safety structure for rotary paper trimmer as in claim 1, wherein the biasing means is configured in such a way that it is only possible for the actuating means to overcome the biasing force of the biasing means after the locking means is disengaged from the blade holder.

8. The safety structure for rotary paper trimmer as in claim 2, wherein the first shoulder has a lower end for engaging with the locking means, and the second shoulder has a lower end for engaging with the biasing means, and the lower end of the first shoulder is at a lower horizontal level than the lower end of the second shoulder.
